(19) United States
(12) Patent Application Publication
(10) Pub. No.: US 2026/0103590 A1
(43) Pub. Date: Apr. 16, 2026

(54) RUBBER COMPOSITION AND PNEUMATIC TIRE

(71) Applicant: Toyo Tire Corporation, Itami-shi (JP)

(72) Inventor: Chi Zhang, Itami-shi (JP)

(73) Assignee: Toyo Tire Corporation, Itami-shi (JP)

(21) Appl. No.: 19/336,662

(22) Filed: Sep. 23, 2025

(30) Foreign Application Priority Data
Oct. 15, 2024 (JP) 2024-179562

(51) Int. Cl. C08L 47/00; B60C 1/00

(52) U.S. Cl. CPC C08L 47/00; B60C 1/0016

(57) ABSTRACT

A rubber composition comprising a diene-based rubber, a filler, an oil, and water-soluble cellulose. It is preferrable that the rubber composition comprises 1 to 25 parts by mass of the water-soluble cellulose per 100 parts by mass of the diene-based rubber. It is preferrable that the water-soluble cellulose is one in which at least a part of hydrogen atoms of hydroxyl groups of cellulose is substituted with at least one substituent selected from the group consisting of a carboxyalkyl group and a hydroxyalkyl group. It is preferrable that the water-soluble cellulose in the state of a 1% aqueous solution at 23° C. has a viscosity of 5,000 to 15,000 mPa·s.

### BACKGROUND OF THE INVENTION

### Field of the Invention

The present invention relates to a rubber composition and a pneumatic tire.

### Description of the Related Art

A pneumatic tire is required to have traveling performance in various situations, and in particular, a studless tire is required to improve, for example, on-ice braking performance (grip performance) on a frozen road surface (icy road surface). In addition, in recent years, characteristics required for a studless tire have become increasingly severe in the market, and not only grip performance but also response performance such as steering response performance and running stability performance (anti-wandering performance) on an icy road surface are required to be improved.

Patent Document 1 below describes a studless tire rubber composition containing 2 to 30 parts by weight of a cellulose fine powder having an average particle diameter of 100 μm or less with respect to 100 parts by weight of a rubber component containing a diene-based rubber.

Patent Document 2 below describes a rubber composition for tires, wherein 25 to 125 parts by mass of a filler containing silica is blended and 0.1 to 30 parts by mass of carboxyalkyl cellulose having an etherification degree of 0.1 to 1.0 and an average particle size of 20 to 100 μm is blended with 100 parts by mass of a rubber component composed of natural rubber and/or diene-based rubber.

Patent Document 3 below describes a winter tire in which a rubber composition containing at least a diene elastomer, a liquid plasticizer of 50 to 100 phr, and a reinforcing filler of between 50 and 150 phr is contained in a tread thereof, wherein the composition further contains powder of magnesium sulfate fine particles as water-soluble fine particles of between 2 and 50 phr, and PVA fibers as water-soluble short fibers of between 2 and 50 phr.

### PRIOR ART DOCUMENTS

### Patent Documents

Patent Document 1: JP-A-2005-29708
Patent Document 2: JP-B2-5694010
Patent Document 3: JP-B2-5778172

### SUMMARY OF THE INVENTION

As a result of intensive studies by the present inventor, it has been found that it is difficult to solve grip performance and response performance on an icy road surface in a balanced way by the techniques described in Patent Documents 1 to 3.

In light of such circumstances, it is an object of the present invention to provide a rubber composition for use as a raw material of a vulcanized rubber for tires with on-ice braking performance (grip performance) and response performance such as steering response performance and running stability performance (anti-wandering performance) on a frozen road surface (icy road surface) improved in a balanced way, and a pneumatic tire including a vulcanized rubber of the rubber composition.

The above object can be achieved by the following configurations. That is, the present invention relates to a rubber composition (1) containing a diene-based rubber, a filler, an oil, and water-soluble cellulose.

The rubber composition (1) is preferably a rubber composition (2) containing 1 to 25 parts by mass of the water-soluble cellulose per 100 parts by mass of the diene-based rubber.

The rubber composition (1) or (2) is preferably a rubber composition (3), wherein the water-soluble cellulose is one in which at least a part of hydrogen atoms of hydroxyl groups of cellulose is substituted with at least one substituent selected from the group consisting of a carboxyalkyl group and a hydroxyalkyl group.

Any one of the rubber compositions (1) to (3) is preferably a rubber composition (4), wherein the water-soluble cellulose in the state of a 1% aqueous solution at 23° C. has a viscosity of 5,000 to 15,000 mPa·s.

The present invention also relates to a pneumatic tire (5) including at least a vulcanized rubber of any one of the rubber compositions (1) to (4), particularly to a studless tire (6) including a vulcanized rubber of any one of the rubber compositions (1) to (4) at least in a tread part.

The rubber composition according to the present invention contains a filler, an oil, and water-soluble cellulose in a diene-based rubber. The vulcanized rubber of the rubber composition having such a configuration can achieve grip performance and response performance on an icy road surface improved in a balanced way. The reason why such an effect is obtained is not clear, but the dispersibility of the water-soluble cellulose in the diene-based rubber is improved in the presence of the filler and the oil. Therefore, the water-soluble cellulose is uniformly dispersed even on the tire surface in contact with the icy road surface, and the water-soluble cellulose can efficiently absorb and remove water from the water membrane on the icy road surface during running of the tire. It is considered that, as a result, the grip performance and response performance on an icy road surface of the vulcanized rubber are improved in a balanced way.

The vulcanized rubber of the rubber composition according to the present invention achieves grip performance and response performance on an icy road surface improved in a balanced way. Therefore, the vulcanized rubber of the rubber composition according to the present invention can be suitably used for pneumatic tires, and is particularly useful as a vulcanized rubber used for tread applications of studless tires.

### DETAILED DESCRIPTION OF THE PREFERRED EMBODIMENTS

The rubber composition according to the present invention contains a diene-based rubber, a filler, an oil, and water-soluble cellulose.

Examples of the diene-based rubber include, but are not limited to, natural rubber (NR), isoprene rubber (IR), butadiene rubber (BR) having no modifying group (functional group), styrene-butadiene rubber (SBR), acrylonitrile-butadiene rubber (NBR), chloroprene rubber (CR), styrene-isoprene copolymer rubber, a butadiene-isoprene copolymer, and styrene-isoprene-butadiene copolymer rubber. These diene-based rubbers may be used singly or in combination of two or more of them.

Examples of the filler include silica and carbon black.

Examples of the silica to be used include silicas usually used for rubber reinforcement, such as wet silica, dry silica, sol-gel silica, and surface-treated silica. Among these, wet silica is preferred. From the viewpoint of solving the problems, in the rubber composition according to the present invention, a content of silica is preferably 20 to 100 parts by mass and more preferably 30 to 80 parts by mass when the total amount of the diene-based rubber is taken as 100 parts by mass.

When silica is contained as a filler, a silane coupling agent is also preferably contained together. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Evonik Japan Co., Ltd.), bis(3-triethoxysilylpropyl)disulfide (e.g., “Si75” manufactured by Evonik Japan Co., Ltd.), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane. The content of the silane coupling agent is preferably 1 to 20 mass % when the total amount of silica is taken as 100 mass %.

Examples of the carbon black that can be used include carbon blacks usually used in the rubber industry, such as SAF, ISAF, HAF, FEF, and GPF; and conductive carbon blacks such as acetylene black and ketjen black. The content of the carbon black in the rubber composition according to the present invention is preferably 1 to 30 parts by mass when the total amount of the diene-based rubber is taken as 100 parts by mass.

Examples of the oil include mineral oils such as paraffinic oil, naphthenic oil, and aromatic oil, and vegetable oils such as linseed oil, safflower oil, soybean oil, corn oil, castor oil, rapeseed oil, and cottonseed oil. These oils may be used singly or in combination of two or more of them. The content of the oil in the rubber composition according to the present invention is preferably 0 to 30 parts by mass when the total amount of the diene-based rubber is taken as 100 parts by mass.

Cellulose has many hydroxyl groups (—OH) which are hydrophilic groups, but is not soluble in water as it is. The water-soluble cellulose is obtained by using cellulose (pulp) widely distributed in nature as a raw material, treating the cellulose with caustic soda, and then subjecting the resulting cellulose to various treatments to be made water-soluble. In the present invention, the water-soluble cellulose is preferably one in which at least a part of hydrogen atoms of hydroxyl groups of cellulose is substituted with at least one substituent selected from the group consisting of a carboxyalkyl group and a hydroxyalkyl group. Examples of the carboxyalkyl group include a carboxymethyl group, a carboxyethyl group, and a carboxypropyl group. Examples of the hydroxyalkyl group include a hydroxymethyl group, a hydroxyethyl group, and a hydroxypropyl group.

In the present invention, the water-soluble cellulose efficiently absorbs and removes water from the water membrane on the icy road surface during running of the tire, whereby the grip performance and response performance on an icy road surface of the vulcanized rubber are improved in a balanced way. In particular, when the water-soluble cellulose in the state of a 1% aqueous solution at 23° C. has a viscosity of 5,000 to 15,000 mPa·s, the water-soluble cellulose can more efficiently absorb and remove water from the water membrane on the icy road surface during running of the tire. As a result, the grip performance and response performance on an icy road surface of the vulcanized rubber are improved in a balanced way, which is preferable. In the present invention, from the viewpoint of solving the problems, it is more preferable to use water-soluble cellulose in the state of a 1% aqueous solution at 23° C. having a viscosity of 8,000 to 15,000 mPa·s.

From the viewpoint of solving the problems, the rubber composition according to the present invention preferably contains 1 to 25 parts by mass and more preferably 2 to 20 parts by mass of the water-soluble cellulose per 100 parts by mass of the diene-based rubber.

The rubber composition according to the present invention contains a diene-based rubber, a filler, an oil, and water-soluble cellulose. The rubber composition according to the present invention may contain, in addition to the above, a vulcanizing agent, a vulcanization accelerator, an antiaging agent, stearic acid, a softener such as wax or oil, a processing aid, and others.

As the vulcanizing agent, sulfur can suitably be used. The sulfur may be ordinary sulfur for rubber, and sulfur such as powdered sulfur, precipitated sulfur, insoluble sulfur, or highly dispersible sulfur can be used. The content of the vulcanizing agent in the rubber composition for tires according to the present invention is preferably 0.1 to 10 parts by mass when the total amount of the diene-based rubber is taken as 100 parts by mass.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

The rubber composition according to the present invention is obtained by kneading a diene-based rubber, a filler, an oil, water-soluble cellulose, a vulcanizing agent, a vulcanization accelerator, zinc oxide, an antiaging agent, stearic acid, a softener such as wax, a processing aid, and others with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

The vulcanized rubber of the rubber composition according to the present invention achieves grip performance and response performance on an icy road surface improved in a particularly balanced way. Therefore, the vulcanized rubber of the rubber composition according to the present invention can be suitably used for pneumatic tires, and is particularly useful as a vulcanized rubber used for tread applications of studless tires.

### Examples

Hereinbelow, the present invention will more specifically be described with reference to examples.

### (Preparation of Rubber Compositions for Tires)

A rubber composition for tires of each of Examples 1 to 7 and Comparative Examples 1 to 4 was prepared by blending compounding agents with 100 parts by mass of a rubber component in accordance with a formulation shown in any one of Tables 1 to 2 and kneading the resultant using an ordinary Banbury mixer. The compounding agent shown in Tables 1 and 2 are as follows.

### (Diene-Based Rubber)

Natural rubber: RSS #3
Butadiene rubber: trade name “BR730”, manufactured by ENEOS Materials Corporation

### (Filler)

Carbon black: trade name “Seast 7HM”, manufactured by TOKAI CARBON CO., LTD.
Silica: trade name “Nipsil AQ”, manufactured by Tosoh Silica Corporation

### (Oil)

Oil: trade name “PROCESS P200”, manufactured by ENEOS Corporation

### (Water-Soluble Cellulose)

Water-soluble carboxymethylcellulose (1): trade name “F1400MC”, manufactured by NIPPON PAPER INDUSTRIES CO., LTD., viscosity of 1% aqueous solution at 23° C.: 13,000 mPa·s
Water-soluble hydroxyethylcellulose (2): trade name “SE900”, manufactured by Daicel Corporation, viscosity of 1% aqueous solution at 23° C.: 5,000 mPa·s
Water-soluble hydroxypropyl methylcellulose (3): trade name “90SH”, manufactured by Shin-Etsu Chemical Co., Ltd., viscosity of 1% aqueous solution at 23° C.: 10,000 mPa·s
Water-soluble carboxymethylcellulose (4): trade name “F10MC”, manufactured by NIPPON PAPER INDUSTRIES CO., LTD., viscosity of 1% aqueous solution at 23° C.: 100 mPa·s

### (Other Compounding Agents)

Insoluble carboxymethylcellulose: trade name “SLD-F1”, manufactured by NIPPON PAPER INDUSTRIES CO., LTD., viscosity of 1% aqueous solution at 23° C.: 100 mPa·s
Unmodified cellulose: trade name “KC FLOCK”, manufactured by NIPPON PAPER INDUSTRIES CO., LTD., viscosity of 1% aqueous solution at 23° C.: 10 mPa·s
Water-soluble polyvinyl alcohol: trade name “POVAL”, manufactured by Kuraray Co., Ltd., viscosity of 1% aqueous solution at 23° C.: 5 mPa·s
Silane coupling agent: trade name “Si-75”, manufactured by Evonik Industries AG
Zinc oxide: trade name “Zinc oxide grade 2”, manufactured by MITSUI MINING & SMELTING CO., LTD.
Stearic acid: trade name “LUNAC S-20”, manufactured by Kao Corporation
Wax: trade name “OZOACE 0355”, manufactured by NIPPON SEIRO CO., LTD.
Antiaging agent: trade name “NOCRAC 6C”, manufactured by OUCHI SHINKO CHEMICAL INDUSTRIAL CO., LTD.
Terpene resin: trade name “SYLVATRAXX 4150”, manufactured by Kraton Corporation
Vulcanization accelerator 1: trade name “SOXINOL CZ”, manufactured by SUMITOMO CHEMICAL COMPANY, LIMITED
Vulcanization accelerator 2: trade name “NOCCELER DZ-G”, manufactured by OUCHI SHINKO CHEMICAL INDUSTRIAL CO., LTD.
Sulfur: trade name “Powder Sulfur”, manufactured by Tsurumi Chemical Industry Co., ltd.

Unvulcanized samples of the rubber compositions of Examples 1 to 7 and Comparative Examples 1 to 4 obtained above were prepared, and then on-ice braking performance and response performance on an icy road surface were evaluated under the following conditions.

### (On-Ice Braking Performance on Icy Road Surface)

A studless tire obtained by applying the obtained rubber composition to a tread was mounted on a 2,000 cc 4WD car, and the ABS was operated at a speed of 40 km/h at an air temperature of −2° C. to −6° C. to measure a braking distance on ice (average value of n=10). The reciprocal of the measured braking distance was expressed as an index when the value in Comparative Example 1 is 100. A larger index indicates that the braking distance is shorter and the on-ice braking performance is better.

### (Response Performance on Icy Road Surface)

A driver in charge of sensory test traveled on a test course on an icy road surface at an air temperature of −2° C. to −6° C. while paying attention to steering responsiveness, running stability (wandering), and the like, and sensory evaluation (evaluation of feeling performance) of response performance was performed. The results are shown in the table, setting an excellent sample as +2, a slightly excellent sample as +1, an equivalent sample as ±0, a slightly poor sample as −1, and a poor sample as −2, as compared with Comparative Example 1 as a control.

TABLE 1

| Comparative | Example | Comparative | Comparative | Example | Example | Example |
|---|---|---|---|---|---|---|
| Example 1 | 1 | Example 2 | Example 3 | 2 | 3 | 4 |

(Formulation)

| | | | | | | | | |
|---|---|---|---|---|---|---|---|---|
| Diene-based | Natural rubber | 50 | 50 | 50 | 50 | 50 | 50 | 50 |
| rubber | Butadiene rubber | 50 | 50 | 50 | 50 | 50 | 50 | 50 |
| Filler | Carbon black | 9 | 9 | 9 | 9 | 9 | 9 | 9 |
| | Silica | 50 | 50 | 50 | 50 | 50 | 50 | 50 |
| Oil | Oil | 20 | 20 | 20 | 20 | 20 | 20 | 20 |
| Water-soluble | Water-soluble | | 10 | | | 2 | 20 | 25 |
| cellulose | carboxymethylcellulose (1) | | | | | | | |
| | Water-soluble | | | | | | | |
| | hydroxyethylcellulose (2) | | | | | | | |
| | Water-soluble hydroxypropyl | | | | | | | |
| | methylcellulose (3) | | | | | | | |
| | Water-soluble | | | | | | | |
| | carboxymethylcellulose (4) | | | | | | | |
| Other | Insoluble carboxymethylcellulose | | | 10 | | | | |
| compounding | Unmodified cellulose | | | | | | | |
| agents | Water-soluble polyvinyl alcohol | | | | 10 | | | |
| | Silane coupling agent | 3.5 | 3.5 | 3.5 | 3.5 | 3.5 | 3.5 | 3.5 |
| | Zinc oxide | 2 | 2 | 2 | 2 | 2 | 2 | 2 |
| | Stearic acid | 2 | 2 | 2 | 2 | 2 | 2 | 2 |
| | Wax | 1.5 | 1.5 | 1.5 | 1.5 | 1.5 | 1.5 | 1.5 |
| | Antiaging agent | 4 | 4 | 4 | 4 | 4 | 4 | 4 |
| | Terpene resin | 10 | 10 | 10 | 10 | 10 | 10 | 10 |
| | Vulcanization accelerator 1 | 0.9 | 0.9 | 0.9 | 0.9 | 0.9 | 0.9 | 0.9 |
| | Vulcanization accelerator 2 | 1.1 | 1.1 | 1.1 | 1.1 | 1.1 | 1.1 | 1.1 |
| | Sulfur | 1.4 | 1.4 | 1.4 | 1.4 | 1.4 | 1.4 | 1.4 |

(Evaluation)

| | | | | | | | | |
|---|---|---|---|---|---|---|---|---|
| Vulcanized | On-ice braking performance | 100 | 112 | 101 | 105 | 103 | 113 | 114 |
| rubber | Response performance | 0 | +2 | −1 | 0 | +1 | +2 | +1 |

As can be seen from the results shown in Table 1, in Example 1, by using the water-soluble carboxymethylcellulose (1) which is a water-soluble cellulose derivative, both the on-ice braking performance and the response performance can be achieved as compared with Comparative Example 1 (conventional technique). Also, in Examples 2 to 4, it can be seen that even when the water-soluble carboxymethylcellulose (1) as a water-soluble cellulose derivative was variously changed, both the on-ice braking performance and the response performance can be achieved as compared with Comparative Example 1 (conventional technique). On the other hand, in Comparative Example 2, it can be seen that even when the insoluble carboxymethylcellulose is used, both the on-ice braking performance and the response performance are not improved or deteriorated as compared with Comparative Example 1 (conventional technique). In addition, in Comparative Example 3, it can be seen that even when the water-soluble polyvinyl alcohol is used, both the on-ice braking performance and the response performance are not improved or are not sufficiently improved as compared with Comparative Example 1 (conventional technique).

TABLE 2

| Comparative | Example | Example | Example | Comparative |
|---|---|---|---|---|
| Example 1 | 5 | 6 | 7 | Example 4 |

(Formulation)

| | | | | | | |
|---|---|---|---|---|---|---|
| Diene-based | Natural rubber | 50 | 50 | 50 | 50 | 50 |
| rubber | Butadiene rubber | 50 | 50 | 50 | 50 | 50 |
| Filler | Carbon black | 9 | 9 | 9 | 9 | 9 |
| | Silica | 50 | 50 | 50 | 50 | 50 |
| Oil | Oil | 20 | 20 | 20 | 20 | 20 |
| Water-soluble | Water-soluble | | | | | |
| cellulose | carboxymethylcellulose (1) | | | | | |
| | Water-soluble | | 10 | | | |
| | hydroxyethylcellulose (2) | | | | | |
| | Water-soluble hydroxypropyl | | | 10 | | |
| | methylcellulose (3) | | | | | |
| | Water-soluble | | | | 10 | |
| | carboxymethylcellulose (4) | | | | | |
| Other | Insoluble carboxymethylcellulose | | | | | |
| compounding | Unmodified cellulose | | | | | 10 |
| agents | Water-soluble polyvinyl alcohol | | | | | |
| | Silane coupling agent | 3.5 | 3.5 | 3.5 | 3.5 | 3.5 |
| | Zinc oxide | 2 | 2 | 2 | 2 | 2 |
| | Stearic acid | 2 | 2 | 2 | 2 | 2 |
| | Wax | 1.5 | 1.5 | 1.5 | 1.5 | 1.5 |
| | Antiaging agent | 4 | 4 | 4 | 4 | 4 |
| | Terpene resin | 10 | 10 | 10 | 10 | 10 |
| | Vulcanization accelerator 1 | 0.9 | 0.9 | 0.9 | 0.9 | 0.9 |
| | Vulcanization accelerator 2 | 1.1 | 1.1 | 1.1 | 1.1 | 1.1 |
| | Sulfur | 1.4 | 1.4 | 1.4 | 1.4 | 1.4 |

(Evaluation)

| | | | | | | |
|---|---|---|---|---|---|---|
| Vulcanized | On-ice braking performance | 100 | 109 | 110 | 103 | 102 |
| rubber | Response performance | 0 | +2 | +2 | +1 | −1 |

As can be seen from the results shown in Table 2, in Examples 5 to 7, even when the water-soluble hydroxyethylcellulose (2), the water-soluble hydroxypropyl methylcellulose (3), and the water-soluble carboxymethylcellulose (4), which are water-soluble cellulose derivatives, are used, both the on-ice braking performance and the response performance can be achieved as compared with Comparative Example 1 (conventional technique). On the other hand, in Comparative Example 4, it can be seen that even when the unmodified cellulose is used, both the on-ice braking performance and the response performance are not improved or deteriorated as compared with Comparative Example 1 (conventional technique).

What is claimed is:

1. A rubber composition comprising a diene-based rubber, a filler, an oil, and water-soluble cellulose.

2. The rubber composition according to claim 1, comprising 1 to 25 parts by mass of the water-soluble cellulose per 100 parts by mass of the diene-based rubber.

3. The rubber composition according to claim 1, wherein the water-soluble cellulose is one in which at least a part of hydrogen atoms of hydroxyl groups of cellulose is substituted with at least one substituent selected from the group consisting of a carboxyalkyl group and a hydroxyalkyl group.

4. The rubber composition according to claim 1, wherein the water-soluble cellulose in the state of a 1% aqueous solution at 23° C. has a viscosity of 5,000 to 15,000 mPa·s.

5. A pneumatic tire comprising a vulcanized rubber of the rubber composition according to claim 1.

6. A studless tire comprising a tread part containing a vulcanized rubber of the rubber composition according to claim 1.
